(19) United States
(12) Patent Application Publication
(10) Pub. No.: US 2012/0050467 A1
(43) Pub. Date: Mar. 1, 2012

(54) IMAGE PROCESSING APPARATUS AND IMAGE PROCESSING METHOD

(76) Inventors: Takaaki Fuchie, Kanagawa (JP); Hiromi Yoshinari, Kanagawa (JP)

(21) Appl. No.: 13/211,916

(22) Filed: Aug. 17, 2011

(30) Foreign Application Priority Data
Aug. 24, 2010 (JP) P2010-187042

(51) Int. Cl. H04N 13/00

(52) U.S. Cl. 348/43; 348/E13.062; 348/E13.073

(57) ABSTRACT

An image processing apparatus includes: a time code reader reading a time code from respective image data of multi-view images; an encoding processing unit performing encoding processing of the image data by each viewpoint; and a control unit controlling start of the encoding processing based on the time code to synchronize picture types in the encoding processing by each viewpoint.

### FIELD

The present disclosure relates to an image processing apparatus and an image processing method. In particular, the present disclosure is made for reducing the difference in image quality between viewpoints in encoding processing of multi-view images.

### BACKGROUND

In recent years, apparatuses of transmitting and accumulating image information with high efficiency when the information is handled as digital data, for example, apparatuses complying with systems such as MPEG which compress images by using orthogonal transformation such as discrete cosine transform and motion compensation are becoming popular in broadcasting stations as well as for family use.

Particularly, MPEG2 (ISO/IEC13818-2) is defined as a general-purpose image coding system and is widely used for extensive applications of professional applications and consumer applications at present. Additionally, H.264 and MPEG-4 Part 10 are standardized as image coding systems which can realize higher coding efficiency, though a larger amount of calculation is necessary for encoding/decoding as compared with the coding systems such as MPEG2.

Recording of stereo images is performed by using the above image coding systems. For example, left-eye images are arranged in odd-numbered fields and right-eye images are arranged in even-numbered fields, and encoding is sequentially performed in the order of an I-picture, a P-picture and a B-picture in JP-A-7-123447 (Patent Document 1).

### SUMMARY

When high-efficiency compression is performed by using the I-picture, the P-picture and the B-picture, difference occurs in picture quality as a state of distortion differs according to the difference of the picture type. Thus, when multi-view images, for example, left-eye images and right-eye images are individually encoded by using a Long GOP (Group Of Picture) structure to generated an encoded stream of stereoscopic images, difference of picture types between the left-eye image and the right-eye image may lead to strange stereoscopic images. Therefore, it is desirable to synchronize the picture types when the left-eye images and the right-eye images are individually encoded by using the Long GOP structure.

Here, when a left-eye image encoding device and a right-eye image encoding device are tightly coupled and the picture types of the left-eye image encoding device and the right-eye image encoding device are designated by one controller, it is easy to synchronize the picture types. However, when the left-eye image encoding device and the right-eye image encoding device are loosely coupled, it is difficult to synchronize the picture types to reduce the difference in image quality between viewpoints. For example, when respective image encoding devices are independently operated in modules, it is difficult to identify picture types used when performing encoding processing by one image encoding device by the other image encoding device unless respective image encoding devices are connected by a high-speed interface to perform communication. Therefore, it is difficult to reduce the difference in image quality between viewpoints in the case of the loose coupling as compared with the case of the tight coupling.

In view of the above; it is desirable to provide an image processing apparatus and an image processing method capable of reducing the difference in image quality between viewpoints when multi-view images are individually encoded.

An embodiment of the present disclosure is directed to an image processing apparatus including a time code reader reading a time code from respective image data of multi-view images, an encoding processing unit performing encoding processing of the image data by each viewpoint, and a control unit controlling start of the encoding processing based on the time code to synchronize picture types in the encoding processing by each viewpoint.

According to this embodiment, when the time code read from image data by the time code reader is, for example, a given value, the control unit starts encoding processing in a Long GOP (Group of Pictures) structure in the encoding processing unit. The control unit also set picture types in the encoding processing. The processing is performed with respect to respective image data of multi-view images, thereby synchronizing picture types and performing the encoding processing. When a scene change is detected by the scene-change detection unit, the GOP structure is changed and the I-picture is inserted. The phases of B-pictures are aligned before and after changing the GOP structure. In the change of the GOP structure, the GOP lengths of a GOP in which the scene change has been detected and a next GOP are changed, then, the I-picture is inserted at the switching of scenes. Additionally, the GOP in which the scene change has been detected is divided and the I-picture is inserted at the switching of scenes.

Another embodiment of the present disclosure is directed to an image processing method performing encoding processing of image data of multi-view images by an image encoding apparatus including reading a time code from respective image data of multi-view images, performing encoding processing of the image data by each viewpoint, and controlling start of the encoding processing based on the time code to synchronize picture types in the encoding processing by each viewpoint.

According to this embodiment, start of the encoding processing is controlled based on the time code read from respective image data of multi-view images, and picture types in the encoding processing by each viewpoint are set as synchronized picture types. Accordingly, when multi-view images are individually encoded, the difference in image quality between viewpoints can be reduced.

### BRIEF DESCRIPTION OF THE DRAWINGS

FIG. 1 is a diagram illustrating a configuration of a first embodiment;

FIG. 2 is a flowchart showing operation in the first embodiment;

FIG. 3 is a flowchart showing picture-type setting processing;

FIGS. 4A to 4D are views illustrating operation in the first embodiment;

FIG. 5 is a diagram illustrating a configuration of a second embodiment;

FIG. 6 is a flowchart showing operation in the second embodiment;

FIG. 7 is a flowchart showing the picture-type setting processing with consideration of a scene change; and

FIGS. 8A to 8E are views illustrating operation in the second embodiment.

### DETAILED DESCRIPTION

Hereinafter, embodiments for carrying out the present disclosure will be explained.

1. First Embodiment

2. Second Embodiment

### 1. First Embodiment

### [Configuration of an Image Processing Apparatus]

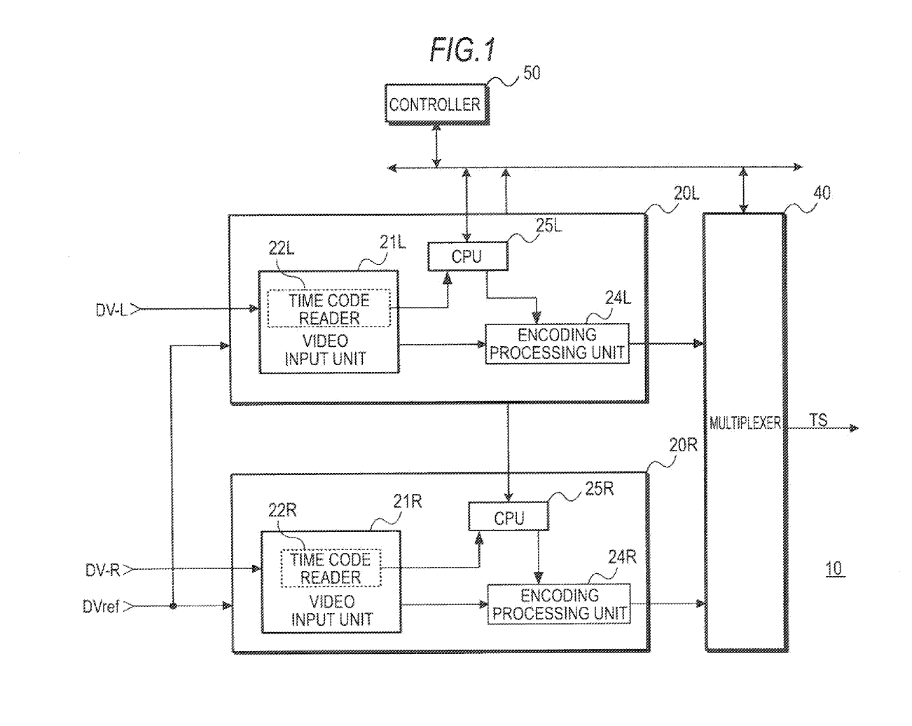

FIG. 1 illustrates a configuration of an image processing apparatus according to an embodiment of the present disclosure. FIG. 1 illustrates the configuration used when encoding processing of, for example, left-eye images and right-eye images are performed as image processing of multi-view images.

An image processing apparatus 10 includes a left-eye image encoding unit 20L performing encoding processing for left-eye images, a right-eye image encoding unit 20R performing encoding processing of right-eye images, a multiplexer 40 and a controller 50.

The left-eye image encoding unit 20L includes a video input unit 21L, an encoding processing unit 24L and a CPU (Central Processing Unit) 25L. The video input unit 21L includes a time code reader 22L.

The video input unit 21L converts a baseband signal DV-L of left-eye images into data corresponding to the encoding processing, for example, luminance data and color-difference data and outputs the data to the encoding processing unit 24L. The time code reader 22L reads a time code included in the baseband signal DV-L and outputs the code to the CPU 25L.

The encoding processing unit 24L performs encoding processing of the left-eye images based on a control signal supplied from the CPU 25L. The encoding processing unit 24L outputs encoded data obtained by the encoding processing of the left-eye images to the multiplexer 40.

The CPU 25L generates the control signal based on an initial setting command and so on supplied from the controller 50 and the time code supplied from the time code reader 22L. The CPU 25L controls operation of the encoding processing unit 24L by supplying the generated control signal to the encoding processing unit 24L.

The right-eye image encoding unit 20R includes a video input unit 21R, an encoding processing unit 24R and a CPU (Central Processing Unit) 25R in the same manner as the left-eye image encoding unit 20L. The video input unit 21R includes a time code reader 22R.

The video input unit 21R converts a baseband signal DV-R of right-eye images into data corresponding to the encoding processing, for example, luminance data and color-difference data and outputs the data to the encoding processing unit 24R. The time code reader 22R reads a time code included in the baseband signal DV-R and outputs the code to the CPU 25R.

The encoding processing unit 24R performs encoding processing of the right-eye images based on a control signal supplied from the CPU 25R. The encoding processing unit 24R outputs encoded data obtained by the encoding processing of the right-eye images to the multiplexer 40.

The CPU 25R generates the control signal based on the initial setting command and so on supplied from the controller 50 and the time code supplied from the time code reader 22R. The CPU 25R controls operation of the encoding processing unit 24R by supplying the generated control signal to the encoding processing unit 24R.

The baseband signal DV-L supplied to the left-eye image encoding unit 20L and the baseband signal DV-R supplied to the right-eye image encoding unit 20R are signals synchronized with a reference video signal DVref. The reference video signal DVref is supplied to the left-eye image encoding unit 20L and the right-eye image encoding unit 20R, and operation synchronized with the reference video signal DVref is performed by the left-eye image encoding unit 20L and the right-eye image encoding unit 20R.

The multiplexer 40 multiplexes encoded data outputted from the left-eye image encoding unit 20L and encoded data outputted from the right-eye image encoding unit 20R and outputs data as one encoded stream TS.

The controller 50 issues the initial setting command and so onto thereby perform setting of encoding conditions in the left-eye image encoding unit 20L and the right-eye image encoding unit 20R, output setting of the multiplexer 40 and soon. For example, the controller 50 performs setting of start timing of the encoding processing, setting of a GOP length, setting of an output bit rate and so on.

### [Operation of the Image Processing Apparatus]

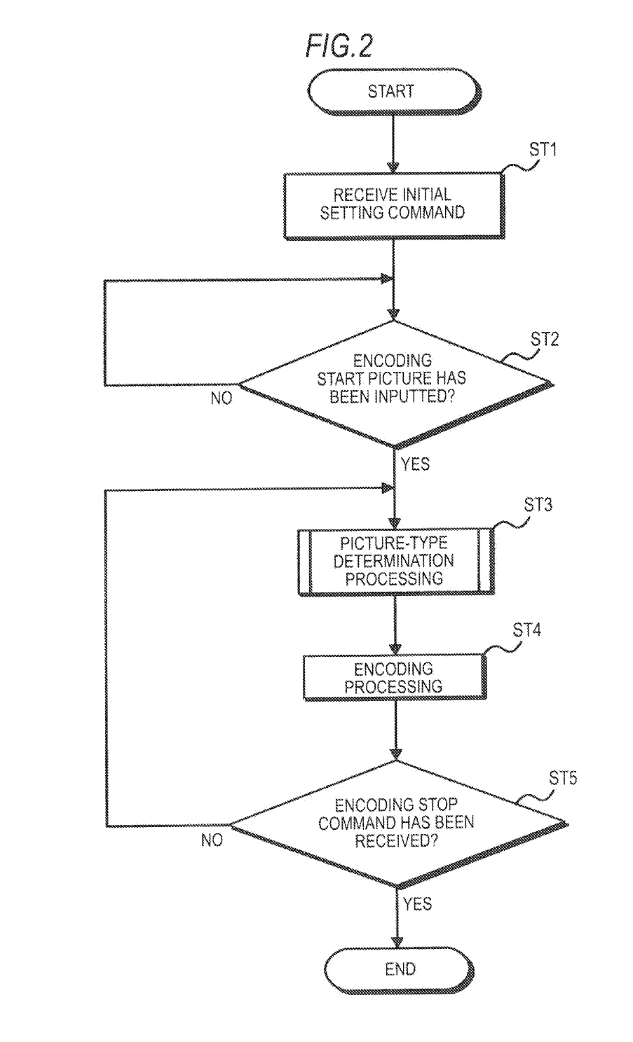

FIG. 2 is a flowchart showing operation in the first embodiment.

In Step ST1, the CPU 25L (25R) receives the initial setting command. The CPU 25L (25R) receives the initial setting command outputted from the controller 50. The CPU 25L (25R) also performs setting of encoding processing based on the received initial setting command. For example, the CPU 25L (25R) performs setting of start timing (a time code value of starting encoding processing) and setting of the Long GOP structure based on the initial setting command and proceeds to Step ST2. In the Long GOP structure set by the initial setting command, the following explanation will be made assuming that the GOP length (the number of pictures included in a GOP) is “N” and the interval of an I picture or a P picture to be a reference image is “M”.

In Step ST2, the CPU 25L (25R) determines whether an encoding start picture has been inputted or not. The CPU 25L (25R) proceeds to Step ST3 when the time code supplied from the time code reader 22L (22R) is the start timing (time code value) which has been set based on the initial setting command. The CPU 25L (25R) returns to Step ST2 when the time code is not the start timing.

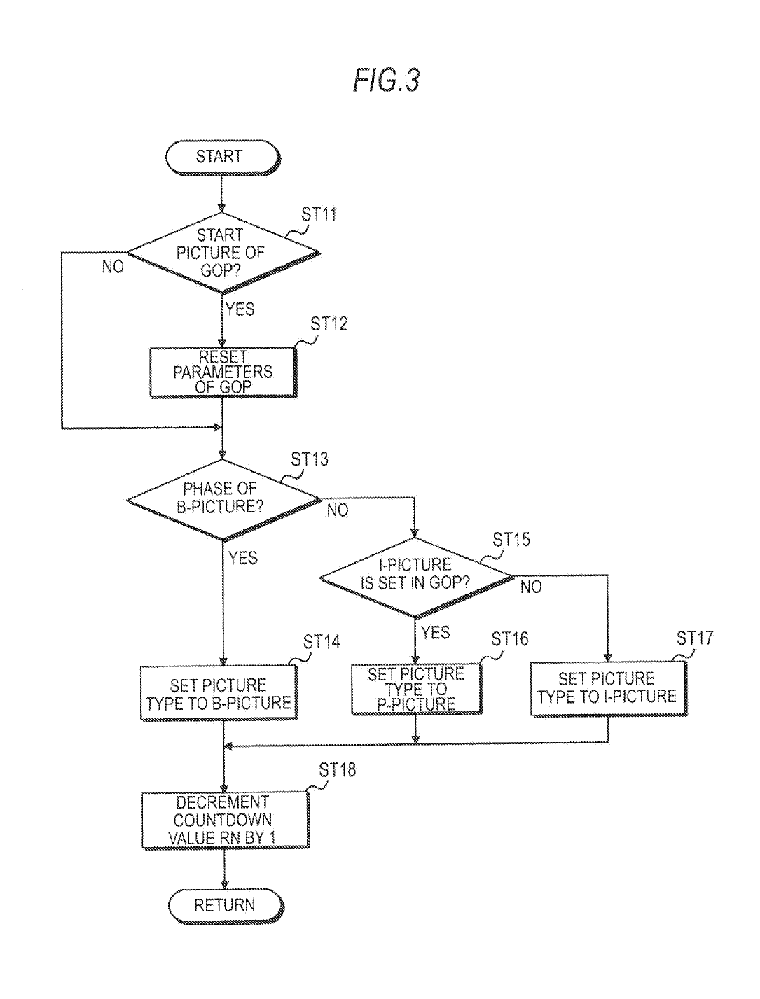

In Step ST3, the CPU 25L (25R) performs setting processing of picture types. FIG. 3 is a flowchart showing the picture-type setting processing.

In Step ST11 of FIG. 3, the CPU 25L (25R) determines whether an image is the start picture of a GOP. The CPU 25L (25R) proceeds to Step ST12 when the image to be encoded is the start picture of the GOP and proceeds to Step ST13 when the image is not the start picture. For example, when a countdown value RN indicating the number of pictures whose picture types have not been set yet in the GOP is “0”, the CPU 25L (25R) determines that the image is the start picture of the GOP and proceeds to Step ST12. When the countdown value RN is not “0”, the CPU 25L (25R) proceeds to Step ST13. The countdown value RN at the time of starting operation is “0”.

In Step ST12, the CPU 25L (25R) resets parameters of the GOP. The CPU 25L (25R) sets the countdown value RN to the number of pictures N in the GOP. The CPU 25L (25R) also turns off an I-picture setting completion flag. The I-picture setting completion flag is turned on when the I-picture is set in the GOP. The CPU 25L (25R) proceeds to Step ST13 after resetting parameters.

In Step ST13, the CPU 25L (25R) determines whether the image has a phase of a B-picture. The CPU 25L (25R) determines that the image has the phase of the B-picture, for example, when a remainder obtained by dividing the countdown value RN by the interval M of the I-picture or the P-picture is not “1”. The CPU 25L (25R) proceeds to Step ST14 when the image to be encoded has the phase of the B-picture and proceeds to Step ST15 when the image does not have the phase of the B-picture.

In Step S14, the CPU 25L (25R) sets the image to be encoded to the B-picture and proceeds to Step ST18.

In Step ST15, the CPU 25L (25R) determines whether the I-picture is set in the GOP. When the I-picture is set in the GOP, for example, when the I-picture setting completion flag is in an on-state, the CPU 25L (25R) proceeds to Step ST16. When the I-picture is not set, for example, when the I-picture setting completion flag is in an off-state, the CPU 25L (25R) proceeds to Step ST17.

In Step ST16, the CPU 25L (25R) sets the picture type to the P-picture. As the image does not have the phase of the B-picture as well as the I-picture has been already set in the GOP, the CPU 25L (25R) sets the image to be encoded to the P-picture and proceeds to Step ST18.

In Step ST17, the CPU 25L (25R) sets the picture type to the I-picture. As the image does not have the phase of the B-picture as well as the I-picture is not set in the GOP, the CPU 25L (25R) sets the image to be encoded to the I-picture and proceeds to Step ST18. The CPU 25L (25R) also turns on the I-picture setting completion flag as the I-picture has been set.

In Step ST18, the CPU 25L (25R) decrements the countdown value RN by 1. As the setting of the picture type has been completed in any of the Step ST14, ST16 and ST17, the CPU 25L (25R) decrements the countdown value RN by 1 and returns to Step ST4 of FIG. 2.

In Step ST4 of FIG. 2, the CPU 25L (25R) allows the encoding processing unit 24L (24R) to perform encoding processing. The CPU 25L (25R) controls the encoding processing unit 24L (24R) to perform encoding processing of the images to be encoded by the picture types set in the picture-type setting processing of Step ST3 and proceeds to Step ST5.

In Step ST5, the CPU 25L (25R) determines whether an encoding stop command has been received. When receiving the encoding stop command from the controller 50, the CPU 25L (25R) completes the encoding processing of the multi-view images. When the encoding stop command has not been received, the CPU 25L (25R) returns to Step ST3 and continues the encoding processing.

As described above, it is possible to synchronize the picture types easily by using the time code read from image data even when the left-eye image encoding unit 20L and the right-eye image encoding unit 20R are loosely coupled. Therefore, it is possible to prevent the generation of strange stereoscopic images in which encoding distortion of the left-eye image differs from encoding distortion of the right-eye image to thereby improve image quality. Additionally, a stereoscopic image system can be easily constructed by using existing image encoding processing units as the picture types can be synchronized based on the time code.

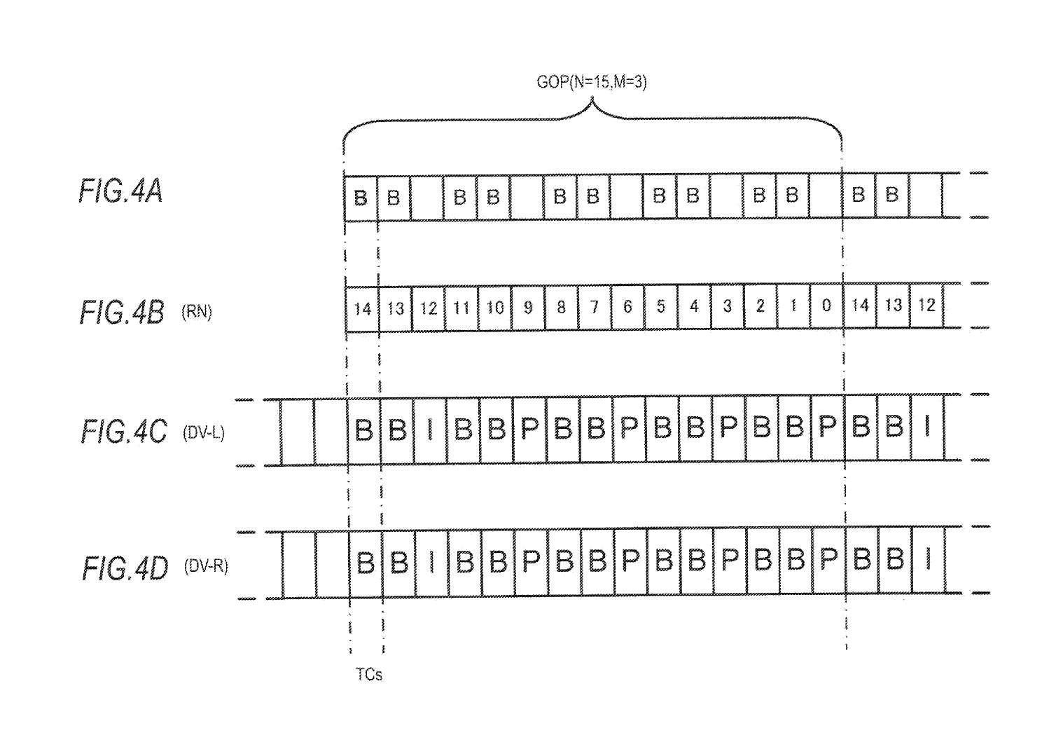

FIGS. 4A to 4D illustrate operation in the first embodiment, showing picture types set by the left-eye image encoding unit 20L and the right-eye image encoding unit 20R respectively. FIGS. 4A to 4D show a case of setting picture types in a fixed cycle assuming that the GOP length is “N=15” and the interval of the 1-picture or the P-picture to be the reference image is “M=3”. The time code value of starting encoding processing by the initial setting command outputted from the controller 50 is set to “TCs”.

FIG. 4A shows phases of the B-picture in the GOP and FIG. 4B shows countdown values RN when the picture types are set. FIG. 4C shows picture types set with respect to the baseband signal DV-L of the left-eye images and FIG. 4D shows picture types set with respect to the baseband signal DV-R of the right-eye images.

The left-eye image encoding unit 20L sets the picture types for respective frames and performs encoding processing when the time code value of the baseband signal DV-L is “TCs”. Similarly, the right-eye image encoding unit 20R sets the picture types for respective frames and performs encoding processing when the time code value of the baseband signal DV-R is “TCs”. The first frame of the GOP is the phase of the B-picture, therefore, the frame in which the time code value is “TCs” (encoding start frame) is set to the B-picture. As the picture type of the first frame has been set, the countdown value RN is “14”.

A frame which is one frame subsequent to the encoding start frame is the phase of the B-picture, therefore, the frame is set to the B-picture. The countdown value RN is “13” as the picture type has been set.

A frame which is two frames subsequent to the encoding start frame is not the phase of the B-picture, and the I-picture has not been set until reaching the frame in the GOP, therefore, the frame is set to the I-picture. The countdown value RN is “12” as the picture type has been set.

Frames which are three frames and four frames subsequent to the encoding start frame are the phase of the B-picture, therefore, the frames are set to the B-picture. A frame which is five frames subsequent to the encoding start frame is not the phase of the B-picture and the I-picture has been set until reaching the frame in the GOP, therefore, the frame is set to the P-picture.

When the picture types are set in subsequent frames in accordance with the above process, the countdown value RN will be “0” in the case where the P-picture is set to the frame fourteen frames subsequent to the encoding start frame. Therefore, parameters of the GOP are reset and picture types can be sequentially set by using a next frame as a head frame of the GOP.

Consequently, even when the left-eye image encoding unit 20L and the right-eye image encoding unit 20R are loosely coupled, the picture types can be synchronized easily as shown in FIG. 4C and FIG. 4D.

In the first embodiment, the time code of starting the encoding processing is set to the same value in the left-eye image and the right-eye image. However, when the frame difference between the start of encoding processing of the left-eye images and the start of encoding processing of the right-eye images is made to be an integral multiple of the GOP length, picture types can be synchronized without starting the encoding processing of the left-eye images and the encoding processing of the right-eye images with the same time code.

### 2. Second Embodiment

When a scene change occurs in the left-eye images or the right-eye images, correlation is low between images before and after the scene change. Therefore, it is possible to prevent reduction of coding efficiency and the deterioration of image quality by inserting the I-picture when the scene change occurs. Accordingly, in the second embodiment, an image processing apparatus capable of responding to the occurrence of the scene change will be explained.

### [Configuration of an Image Processing Apparatus]

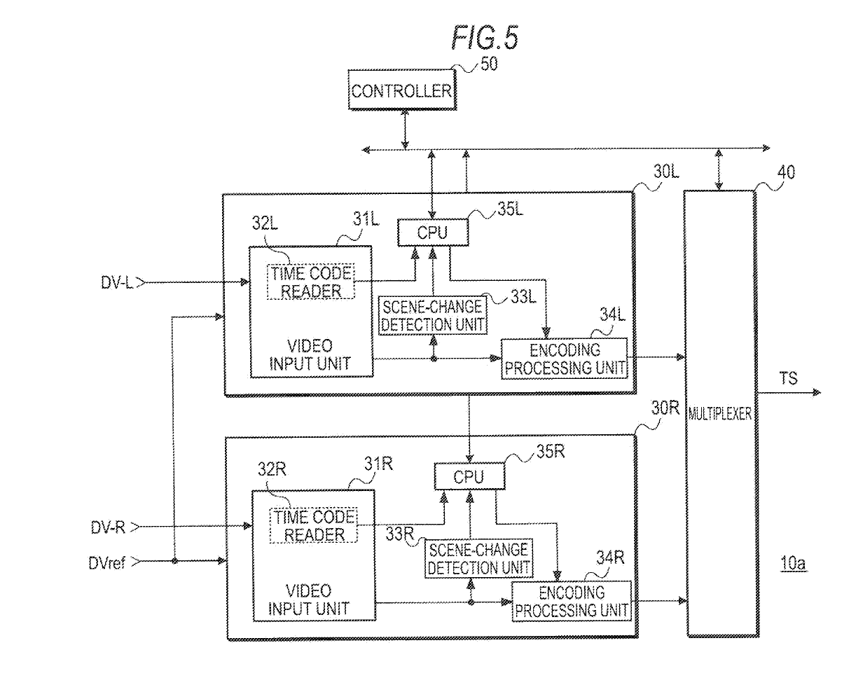

FIG. 5 illustrates a configuration of an image processing apparatus according to a second embodiment. FIG. 5 also illustrates the configuration used when encoding processing of, for example, left-eye images and right-eye images is performed as image processing of multi-view images.

An image processing apparatus 10a includes a left-eye image encoding unit 30L performing encoding processing for left-eye images, a right-eye image encoding unit 30R performing encoding processing of right-eye images, the multiplexer 40 and the controller 50.

The left-eye image encoding unit 30L includes a video input unit 31L, a scene-change detection unit 33L, an encoding processing unit 34L and a CPU (Central Processing Unit) 35L. The video input unit 31L includes a time code reader 32L.

The video input unit 31L converts a baseband signal DV-L of left-eye images into data corresponding to the encoding processing, for example, luminance data and color-difference data to the scene-change detection unit 33L and the encoding processing unit 34L. The time code reader 32L reads a time code included in the baseband signal DV-L and outputs the code to the CPU 35L.

The scene-change detection unit 33L detects a scene change based on luminance data or color-difference data of the left-eye images outputted from the video input unit 31L and outputs a scene-change detection signal to the CPU 35L.

The encoding processing unit 34L performs encoding processing of the left-eye images based on a control signal supplied from the CPU 35L. The encoding processing unit 34L outputs encoded data obtained by the encoding processing of the left-eye images to the multiplexer 40.

The CPU 35L generates the control signal based on an initial setting command and so on supplied from the controller 50 and the time code supplied from the time code reader 32L. The CPU 35L controls operation of the encoding processing unit 34L by supplying the generated control signal to the encoding processing unit 34L. The CPU 35L also changes the GOP structure and inserts the I-picture when the detection of the scene change is determined based on the scene-change detection signal supplied from the scene-change detection unit 33L.

The right-eye image encoding unit 30R includes a video input unit 31R, a scene-change detection unit 33R, an encoding processing unit 34R and a CPU (Central Processing Unit) 35R. The video input unit 31R includes a time code reader 32R.

The video input unit 31R converts a baseband signal DV-R of right-eye images into data corresponding to the encoding processing, for example, luminance data and color-difference data to scene-change detection unit 33R and the encoding processing unit 34R. The time code reader 32R reads a time code included in the baseband signal DV-R and outputs the code to the CPU 35R.

The scene-change detection unit 33R detects a scene change based on luminance data or color-difference data of the right-eye images outputted from the video input unit 31R and outputs a scene-change detection signal to the CPU 35R.

The encoding processing unit 34R performs encoding processing of the right-eye images based on a control signal supplied from the CPU 35R. The encoding processing unit 34R outputs encoded data obtained by the encoding processing of the left-eye images to the multiplexer 40.

The CPU 35R generates the control signal based on the initial setting command and so on supplied from the controller 50 and the time code supplied from the time code reader 32R. The CPU 35R controls operation of the encoding processing unit 34R by supplying the generated control signal to the encoding processing unit 34R. The CPU 35R also changes the GOP structure and inserts the I-picture when the detection of the scene change is determined based on the scene-change detection signal supplied from the scene change detection unit 33R.

The baseband signal DV-L supplied to the left-eye image encoding unit 30L and the baseband signal DV-R supplied to the right-eye image encoding unit 30R are signals synchronized with the reference video signal DVref. The reference video signal DVref is supplied to the left-eye image encoding unit 30L and the right-eye image encoding unit 30R, and operation synchronized with the reference video signal DVref is performed by the left-eye image encoding unit 30L and the right-eye image encoding unit 30R.

The multiplexer 40 multiplexes encoded data outputted from the left-eye image encoding unit 30L and encoded data outputted from the right-eye image encoding unit 30R and outputs data as one encoded stream TS.

The controller 50 issues the initial setting command and so on to thereby perform setting of encoding conditions in the left-eye image encoding unit 30L and the right-eye image encoding unit 30R, output setting of the multiplexer 40 and so on. For example, the controller 50 performs setting of start timing of the encoding processing, setting of the GOP length, setting of the output bit rate and so on.

### [Operation of the Image Processing Apparatus]

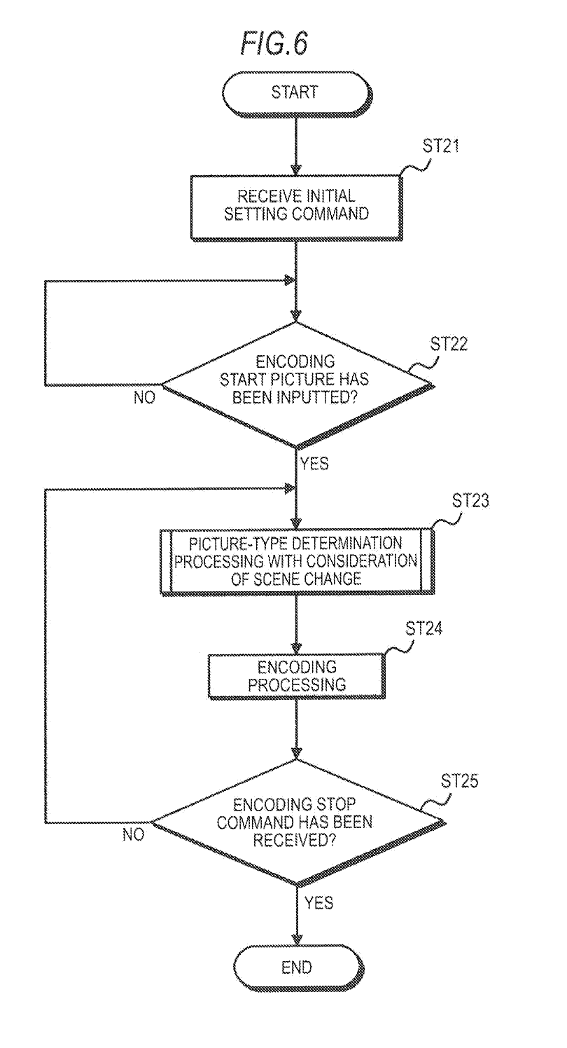

FIG. 6 is a flowchart showing operation in the second embodiment.

In Step ST21, the CPU 35L (35R) receives the initial setting command. The CPU 35L (35R) receives the initial setting command outputted from the controller 50. The CPU 35L (35R) also performs setting of encoding processing based on the received initial setting command. For example, the CPU 35L (35R) performs setting of start timing (a time code value of starting encoding processing) and setting of the Long GOP structure based on the initial setting command and proceeds to Step ST22. In the Long GOP structure set by the initial setting command, the following explanation will be made assuming that the GOP length (the number of pictures included in the GOP) is “N” and the interval of the I-picture or the P-picture to be a reference image is “M”.

In Step ST22, the CPU 35L (35R) determines whether the encoding start picture has been inputted or not. The CPU 35L (35R) proceeds to Step ST23 when the time code supplied from the time code reader 32L (32R) is the start timing (time code value) which has been set based on the initial setting command. The CPU 35L (35R) returns to Step ST22 when the time code is not the start timing.

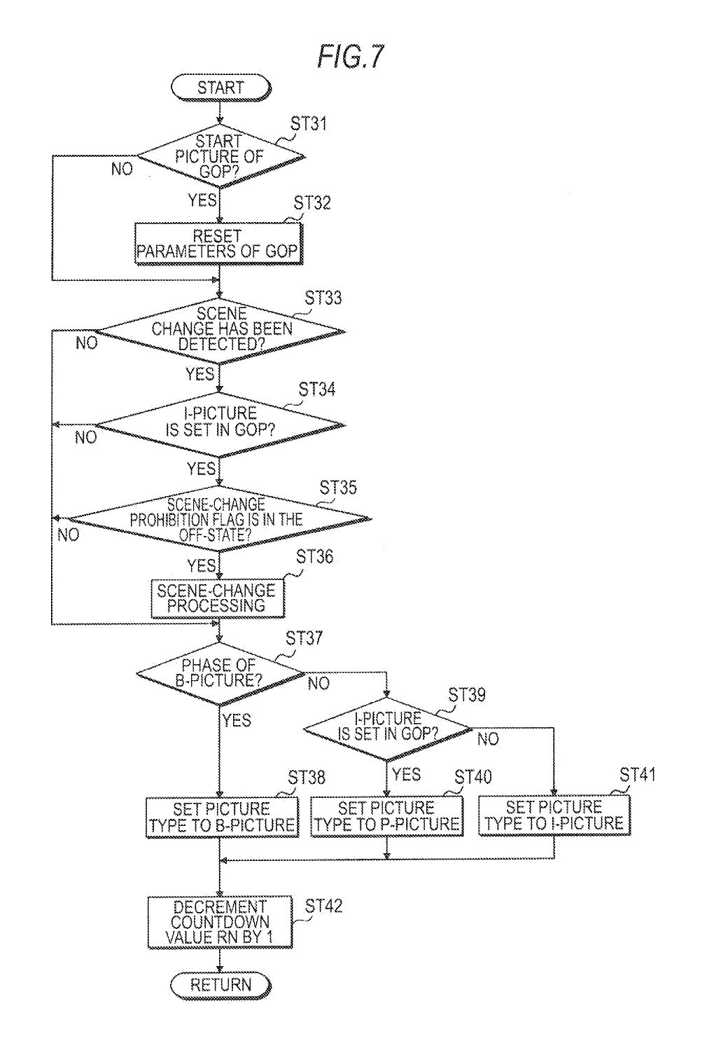

In Step ST23, the CPU 35L (35R) performs setting processing of picture types with consideration of the scene change. FIG. 7 is a flowchart showing the picture-type setting processing with consideration of the scene change.

In Step ST31 of FIG. 7, the CPU 35L (35R) determines whether the frame is the start picture of a GOP. The CPU 35L (35R) proceeds to Step ST32 when the image to be encoded is the start picture of the GOP and proceeds to Step ST33 when the image is not the start picture. For example, when the countdown value RN indicating the number of pictures whose picture types have not been set yet in the GOP is “0”, the CPU 35L (35R) determines that the image is the start picture of the GOP and proceeds to Step ST32. When the countdown value RN is not “0”, the CPU 35L (35R) proceeds to Step ST33. The countdown value RN at the time of starting operation is “0”.

In Step ST32, the CPU 35L (35R) resets parameters of the GOP. The CPU 35L (35R) sets the countdown value RN to the number of pictures N in the GOP. The CPU 35L (35R) turns off an I-picture setting completion flag. The I-picture setting completion flag is turned on when the I-picture is set in the GOP. The CPU 35L (35R) turns off a scene-change detection flag. The CPU 35L (35R) proceeds to Step ST33 after resetting parameters.

In Step S33, the CPU 35L (35R) determines whether a scene change has been detected. The CPU 35L (35R) proceeds to Step S34 when it is determined that the scene change has been detected by the scene-change detection unit 33L (33R) based on the scene-change detection result supplied from the scene-change detection unit 33L (33R). The CPU 35L (35R) proceeds to Step S37 when it is not determined that the scene change has been detected.

The CPU 35L (35R) determines whether the I-picture is set in GOP in Step ST34. When the I-picture is set in the GOP, for example, when the I-picture setting completion flag is in the on-state, the CPU 35L (35R) proceeds to Step ST35. When the I-picture is not set, for example, when the I-picture setting completion flag is in the off-state, the CPU 35L (35R) proceeds to Step ST37.

In Step ST35, the CPU 35L (35R) determines whether a scene-change prohibition flag is in the off-state. The scene-change prohibition flag is a flag indicating whether the CPU is in a scene-change processing period during which the GOP structure is changed when the scene change is detected. The scene-change prohibition flag is turned on when the CPU is in the scene-change processing period. The CPU 35L (35R) proceeds to Step ST36 when the scene-change prohibition flag is in the off-state and proceeds to Step ST37 when the flag is in the on-state.

In Step ST36, the CPU 35L (35R) performs scene-change processing. The CPU 35L (35R) changes the GOP structure and inserts the I-picture when the scene change is detected, then, proceeds to Step ST37. For example, the CPU 35L (35R) adds the number of pictures N in the GOP to the countdown value RN to obtain a new countdown value RN as the scene change processing. The CPU 35L (35R) turns off the I-picture setting completion flag and turns on the scene-change prohibition flag. The CPU 35L (35R) aligns phases of B-pictures before and after changing the GOP structure and inserts the I-picture.

In Step ST37, the CPU 35L (35R) determines whether the image has a phase of a B-picture. The CPU 35L (35R) determines that the image has the phase of the B-picture, for example, when a remainder obtained by dividing the countdown value RN by the interval M of the I-picture or the P-picture is not “1”, The CPU 35L (35R) proceeds to Step ST38 when the image to be encoded has the phase of the B-picture and proceeds to Step ST39 when the image does not have the phase of the B-picture.

In Step ST38, the CPU 35L (35R) sets the image to be encoded to the B-picture and proceeds to Step ST42.

In Step ST39, the CPU 35L (35R) determines whether the I-picture is set in the GOP. When the I-picture is set in the GOP, for example, when the I-picture setting completion flag is in the on-state, the CPU 35L (35R) proceeds to Step ST40. When the I-picture is not set, for example, when the I-picture setting completion flag is in the off-state, the CPU 35L (35R) proceeds to Step ST41.

In Step ST40, the CPU 35L (35R) sets the picture type to the P-picture. As the image does not have the phase of the B-picture as well as the I-picture has been already set in the GOP, the CPU 35L (35R) sets the image to be encoded to the P-picture and proceeds to Step ST42.

In Step ST41, the CPU 35L (35R) sets the picture type to the I-picture. As the image does not have the phase of the B-picture as well as the I-picture is not set in the GOP, the CPU 35L (35R) sets the image to be encoded to the I-picture and proceeds to Step ST42. The CPU 35L (35R) also turns on the I-picture setting completion flag as the I-picture has been set.

In Step ST42, the CPU 35L (35R) decrements the countdown value RN by 1. As the setting of the picture type has been completed in any of the Step ST38, ST40 and ST41, the CPU 35L (35R) decrements the countdown value RN by 1 and returns to Step ST24 of FIG. 6.

In Step ST24 of FIG. 6, the CPU 35L (35R) allows the encoding processing unit 34L (34R) to perform encoding processing. The CPU 35L (35R) controls the encoding processing unit 34L (34R) to perform encoding processing of the images to be encoded by the picture types set in the picture-type setting processing of Step ST23 and proceeds to Step ST25.

In Step ST25, the CPU 35L (35R) determines whether an encoding stop command has been received. When receiving the encoding stop command from the controller 50, the CPU 35L (35R) completes the encoding processing of the multi-view images. When the encoding stop command has not been received, the CPU 35L (35R) returns to Step ST23.

As described above, it is possible to synchronize the picture types easily by using the time code read from image data even when the left-eye image encoding unit 30L and the right-eye image encoding unit 30R are loosely coupled. Therefore, it is possible to prevent the generation of strange stereoscopic images in which encoding distortion of the left-eye image differs from encoding distortion of the right-eye image to thereby improve image quality. Additionally, the stereoscopic image system can be easily constructed by using existing image encoding processing units as the picture types can be synchronized based on the time code. Furthermore; the GOP structure is changed and the I-picture is inserted when the scene change is detected, therefore, it is possible to prevent reduction of coding efficiency and deterioration of image quality due to reduction of correlation of images by the generation of the scene change.

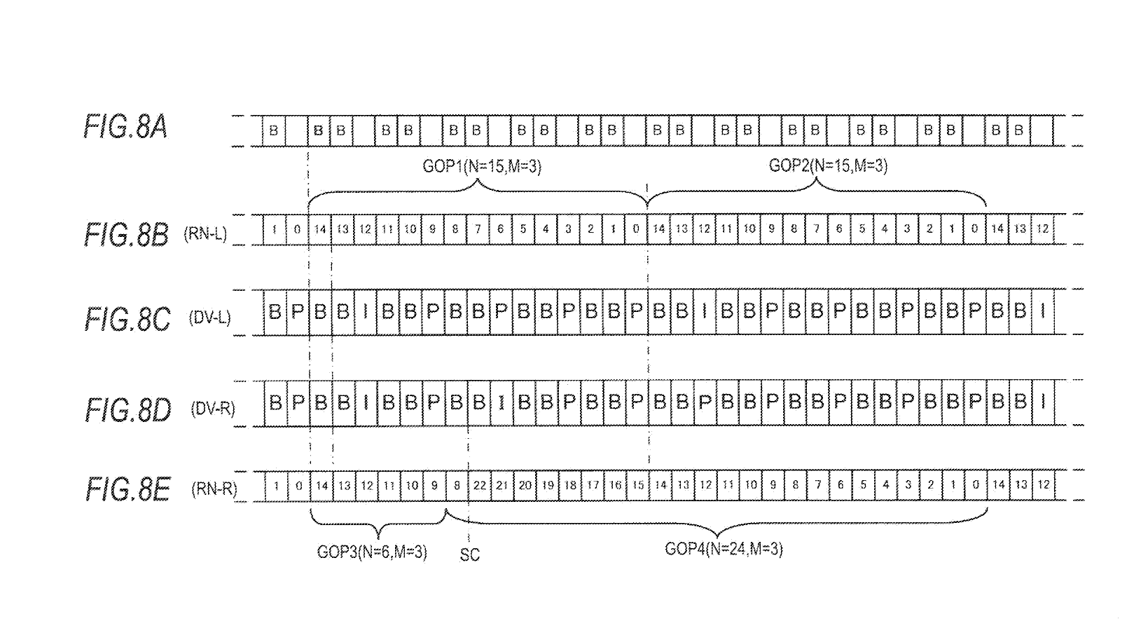

FIGS. 8A to 8E illustrate operation in the second embodiment, showing picture types set by the left-eye image encoding unit 30L and the right-eye image encoding unit 30R respectively in the case where the scene change occurs in the right-eye image. FIGS. 8A to 8E show a case of setting picture types in a fixed cycle assuming that the GOP length is “N=15” and the interval of the I-picture or the P-picture to be the reference image is “M=3”.

FIG. 8A shows phases of the B-picture in the GOP and FIG. 8B shows countdown values RN-L in the left-eye image encoding unit 30L when the picture types are set. FIG. 8C shows picture types set with respect to the baseband signal DV-L of the left-eye images, FIG. 8D shows picture types set with respect to the baseband signal DV-R of the right-eye images and FIG. 8E shows countdown values RN-R in the right-eye image encoding unit 30R when the picture types are set.

The right-eye image encoding unit 30R performs the scene change processing in the case where the I-picture is set in a GOP 1 and the scene-change detection flag is in the off-state, for example, when a scene change SC is detected in the eighth frame from the head of the GOP1. The right-eye image encoding unit 30R performs the scene change processing and adds the number of pictures N in the GOP to the countdown value RN to obtain a new countdown value RN. The right-eye image encoding unit 30R also turns off the I-picture setting completion flag and turns on the scene-change prohibition flag. The right-eye image encoding unit 30R further sets the I-picture in the ninth-frame from the head of the GOP1 as phases of B-pictures are aligned before and after changing the GOP structure and the I-picture is inserted.

As described above, the GOP lengths of the GOP in which the scene change has been detected and a next GOP are changed and the I-picture is inserted at the switching of scenes. That is, structures of the GOP1 (N=15, M=3) and a GOP2 (N=15, M=2) are changed to structures of a GOP3 (N=6, M=3) and a GOP 4 (N=24, M=3), and the I-picture is inserted at the switching of scenes. In this case, there are a frame in which a left-eye image is the P-picture and a right-eye image is the I-picture and a frame in which a left-eye image is the I-picture and a right-eye image is the P-picture in two GOP periods, however, picture types can be synchronized in remaining frames. Additionally, the number of GOPs is the same regardless of existence of scene change, therefore, reduction of the coding efficiency due to increase in the number of GOPs can be avoided.

When giving priority to synchronization of picture types, the GOP in which the scene change has been detected is divided and the I-picture is inserted at the switching of scenes. For example, the number of pictures N in the GOP is not added to the countdown value RN. In this case, in the right-eye image encoding unit 30R which has detected the scene change, the GOP1 (N=15, M=3) is divided into two GOPs including a GOP (N=6, M=3) and a GOP (N=9, M=3) and the structure of the GOP2 (N=15, M=3) is not changed. That is, one GOP is added, however, there exist only one frame in which the picture type differs between the left-eye image and the right-eye image.

The present disclosure should not be taken to be limited to the above embodiments. In the above embodiments, the case where the left-eye image and the right-eye image are encoded as multi-view images has been explained. However, the multi-view images are not limited to the above images. For example, the technology can be applied to a case where the number of modules of the image encoding device is increased and many multi-view images are encoded. The above embodiments are illustrative of the present disclosure and it is obvious that those skilled in the art may made modifications and alternations within the scope of the gist of the present disclosure. That is, appended claims should be taken into consideration for determining the gist of the present disclosure.

In the image processing apparatus and the image processing method according to embodiments of the present disclosure, the start of encoding processing is controlled based on the time code read from respective image data of multi-view images, and picture types in the encoding processing in respective viewpoints are set as synchronized picture types. Accordingly, it is possible to reduce the difference in image quality between viewpoints easily when multi-view images are encoded individually. Therefore, the technology is suitable for, for example, an imaging apparatus generating image data of multi-view images, an editing apparatus performing editing processing of multi-view images and the like.

The present disclosure contains subject matter related to that disclosed in Japanese Priority Patent Application JP 2010-187042 filed in the Japan Patent Office on Aug. 24, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus comprising:
a time code reader reading a time code from respective image data of multi-view images;
an encoding processing unit performing encoding processing of the image data by each viewpoint; and
a control unit controlling start of the encoding processing based on the time code to synchronize picture types in the encoding processing by each viewpoint.

2. The image processing apparatus according to claim 1, further comprising:
a scene-change detection unit detecting a scene change by using the image data,
wherein the control unit changes a GOP (Group of Pictures) structure and inserts an I-picture when the scene change is detected.

3. The image processing apparatus according to claim 2,
wherein the control unit aligns phases of B-pictures before and after changing the GOP structure.

4. The image processing apparatus according to claim 3,
wherein the control unit changes GOP lengths of a GOP in which the scene change has been detected and a next GOP, inserting the I-picture at the switching of scenes.

5. The image processing apparatus according to claim 3,
wherein the control unit divides the GOP in which the scene change has been detected and inserts the I-picture at the switching of scenes.

6. An image processing method performing encoding processing of image data of multi-view images by an image encoding apparatus, comprising:
reading a time code from respective image data of multi-view images;
performing encoding processing of the image data by each viewpoint; and
controlling start of the encoding processing based on the time code to synchronize picture types in the encoding processing by each viewpoint.
